(19) United States
(12) Patent Application Publication
(10) Pub. No.: US 2010/0237567 A1
(43) Pub. Date: Sep. 23, 2010

(54) SEALING ELEMENT

(76) Inventors: Jürgen Kurth, Odenthal (DE); Jürgen Netzer, Burscheid (DE)

Correspondence Address: SKF USA Inc., 890 Forty Foot Road, PO Box 352, Lansdale, PA, 19446, US

(21) Appl. No.: 12/733,013

(22) PCT Filed: Jul. 22, 2008
(86) PCT No.: PCT/EP2008/006000

§ 371 Date: May 25, 2010

(30) Foreign Application Priority Data
Aug. 2, 2007 (DE) 10 2007 036 625.8

(51) Int. Cl. F16J 15/32

(52) U.S. Cl. 277/559

(57) ABSTRACT

A sealing element for sealing a shaft, which is provided for rotating in accordance with its design, at a through-opening of a housing part for the shaft, comprising the following features:
a reinforcement part (2) and an elastomeric part (5) connected with the reinforcement part,
the elastomeric part (5) comprises a first sealing region (10) for a static-sealing abutment on the housing part and
the elastomeric part comprises a second sealing region (20) having a sealing segment (22) formed and provided for sealing abutment on the shaft, which sealing segment comprises a thread-like return structure for a return of a leaked fluid into a to-be-sealed space, and a free axial end in the sealing segment normally abutting on the shaft is formed with a closed line (26) in the circumferential direction and extending on a circular-cylinder surface, which line is provided for sealing abutment on the shaft at least when the shaft is not rotating.

The invention concerns a sealing element for sealing a shaft, which is provided for rotating in accordance with its design, at a through-opening of a housing part for the shaft.

Especially for internal combustion engines and transmissions in the automotive field, special demands are placed on the shaft seals utilized therein with respect to service life, frictional loss and installation dependability. For this purpose, radial shaft sealing rings are known that have sealing lips made from highly chemically-resistant polytetrafluoroethylene (PTFE) and a spiral-shaped conveying structure, e.g., for a synthetic oil of the internal combustion engine. To minimize the frictional losses, the lip cross-sections that are expanded by the shaft are reduced as far as into the range of the PTFE-particle sizes and the already good sliding properties of the PTFE are improved to some extent by filling materials, such as graphite or molybdenum disulfide. As a result, the seal design optimized for the above-indicated usage necessitates a special carefulness during the installation in order to avoid damaging the sealing lip materials made from PTFE, which are relatively inelastic as compared to fluoropolymer seals. Furthermore, to verify the proper and damage-free positioning of the sealing lip after its installation, the shaft seal is subjected more and more frequently to an automated pressure- and/or vacuum test on the assembly line of the internal combustion engine or transmission. Due to the low elasticity of the PTFE-sealing lip, its low intrinsic attachment force to the shaft, the structure of the shaft contact surface, which is amorphous due to its glass fiber filling material, and its spiral-shaped oil return structure, which opens to the atmosphere, its contact region for the shaft can not be sufficiently closed in a gas-tight manner without additional additives. For this reason, the sealing gap must be temporarily closed during the above-mentioned pressure- and/or vacuum tests, e.g., by using waxes or greases that vaporize during operation of the transmission or the internal combustion engine. Thus, a defective application procedure for the wax or an installation-induced damage of the wax layer during the inspections on the assembly line during said pressure- and/or vacuum test can lead to an apparent leakiness that disadvantageously leads to the rejection of the shaft seal, which is actually defect-free, and thus to the rejection of the transmission or the internal combustion engine.

Thus, it is an object of the present invention to provide an improved sealing element, which exhibits good sealing properties for a simple and thus cost-effective manufacture-ability for operation in accordance with its design as well as for inspection- and test-purposes.

This object is achieved by the subject matter of claim 1. Advantageous embodiments are described in the dependent claims.

In accordance with a claim, a sealing element for sealing a shaft, which is provided for rotating in accordance with its design, at a through-opening of a housing part for the shaft, comprises the following features:
a reinforcement part and an elastomeric part connected with the reinforcement part,
the elastomeric part comprises a first sealing region for a static-sealing abutment on the housing part and
the elastomeric part comprises a second sealing region having a sealing segment formed and provided for sealing abutment on the shaft, which sealing segment comprises a thread-like return structure for a return of a leaked fluid into a to-be-sealed space, and a free axial end in the sealing segment abutting on the shaft in accordance with its design is formed with a closed line in the circumferential direction and extending on a circular-cylinder surface, which line is provided for sealing abutment on the shaft at least when the shaft is not rotating.

The inventive sealing element thus offers, while taking into account the application-specific requirements of seal tightness, service life, frictional losses and power dissipation, the advantage of automated installation and inspection by a gas-leakage test, which is disposed downstream of the installation. By making the dynamic sealing region from an elastomeric material, the sealing segment has a higher elasticity, in particular relative to a comparable embodiment made from PTFE, whereby a defined, static, gas-tight contact is possible due to the elastic abutment-capability of the sealing segment, in particular due to the closed line radially extending on the circular-cylindrical surface to an opposing surface of the shaft, whereby in turn said pressure- and/or vacuum test is advantageously possible without an application of supplemental materials onto the sealing segment. Furthermore, the inventive sealing element is formed in a manner especially adapted for achieving a frictional loss as low as possible relative to comparable known embodiments by means of a sealing segment having a reduced wall thickness and at the same time with a low intrinsic radial force.

Further advantages, features and details of the invention result from the exemplary embodiments of the invention described in the following with the assistance of the Figures.

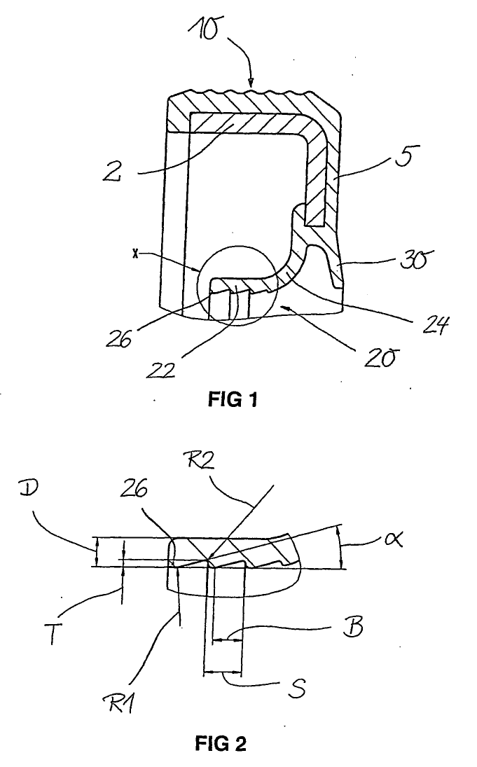

FIG. 1 shows a longitudinal section through an upper half of a sealing element in a first embodiment,

FIG. 2 shows an enlarged cut-out of the area indicated by X in FIG. 1,

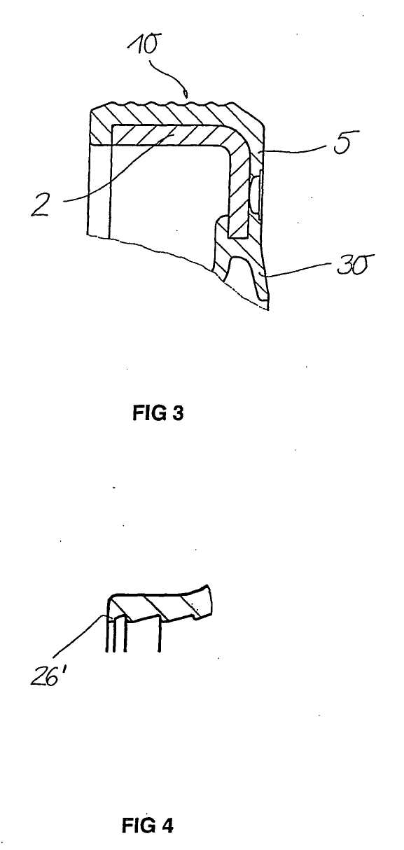

FIG. 3 shows a longitudinal section through an upper half of the sealing element of FIG. 1 at another circumferential position,

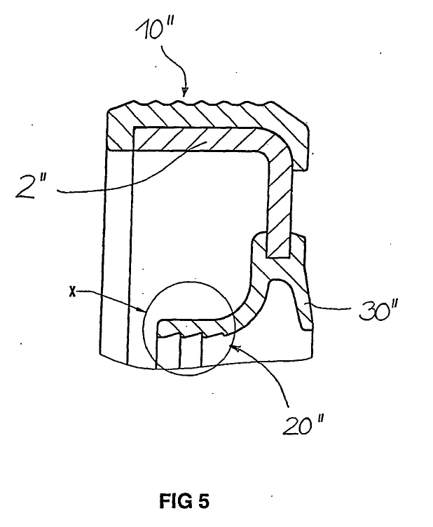

FIG. 4 shows a free axial end of the sealing segment that is designed in an alternate manner with respect to FIG. 2, and

FIG. 5 shows a longitudinal section through an upper half of a sealing element in a second embodiment.

As an exemplary embodiment of the invention, FIG. 1 shows a longitudinal section through an upper half of a sealing element in a first embodiment. In this case, the annular-shaped sealing element comprises a reinforcement part 2 as well as a one-piece elastomeric part 5 connected with the reinforcement part 2. In this case, the reinforcement part 2 is formed, e.g., from a metal plate. The elastomeric part 5 is formed from an elastomeric material, in particular a fluoroelastomer, which can contain PTFE-nanoparticles, and is connected with the reinforcement part 2 by vulcanizing onto the reinforcement part 2.

In this case, the elastomeric part 5 comprises a first sealing region 10, whose outer surface is formed for static-sealing abutment on a not-illustrated housing part in the region of a through-opening for a to-be-sealed shaft, which is also not illustrated. This embodiment concerns, e.g., an internal combustion engine, wherein an oil chamber of the motor is disposed on the left side of FIG. 1 and an air-side of the internal combustion engine associated with the ambient atmosphere is located on the right side of FIG. 1.

Further, the elastomeric part 5 comprises a second sealing region 20, which comprises a substantially hollow cylinder-like sealing segment 22, which abuts on the not-illustrated shaft when the sealing element is installed in accordance with its design. This sealing segment 22, which is formed with a thread-like return structure, then smoothly transitions towards the right side into a trumpet-like enlarged segment 24. In the illustrated embodiment, the trumpet-like segment 24 projects into the oil chamber with its cross-section decreasing into the oil chamber. Finally, the elastomeric part 5 is designed with a secondary sealing lip 30 towards the air-side.

In other embodiments, the sealing element of FIG. 1 can be attached to the reinforcement element 2 in a vertically-mirrored manner, e.g., while omitting the secondary sealing lip 30, so that the trumpet-like segment 24 is disposed in a manner that widens the oil chamber towards the air side, wherein the conveying structure for a return force towards the oil chamber can be adapted, if desired, in a corresponding manner.

For this purpose, at least the inner surface of the hollow cylinder-like sealing segment 22 is formed with the thread-like return structure that applies, when the shaft rotates in the direction of rotation in accordance with its design, a return force to oil penetrating between the shaft and the sealing segment 22.

On the left, i.e. on the free axial end of the sealing segment 22, the thread of the return structure ends at an annular-like, radially encompassing, closed region 26 of the sealing segment 22 having a circular cylinder-like inner surface; the sealing segment 22 is provided for sealing abutment on the shaft at least when the shaft is not rotating. This annular-like region 26 of the sealing segment 22 thus forms, in combination with the material properties of the elastomeric material, the condition that the sealing element also abuts on the shaft in a gas-tight manner also when the shaft is not rotating, so that the internal combustion engine can be subjected to a pressure- and/or vacuum test to check the correct installation of the sealing element and the sealing force without having to apply additional materials between the sealing segment 22 and the shaft.

For this purpose, the transition of the thread of the return structure into the annular-like region 26 is designed such that the tread transitions into the annular-like region 26 with decreasing depth but with a profile that remains proportioned the same. Thus, it was recognized that a transition designed in this manner positively influences a return behavior for comparably simple manufacturability to the effect that a floating of the annular-like region 26 is fostered when the shaft is rotating and the oil to-be-returned and so that after the floating a return can begin to take place.

FIG. 2 shows a cut-out enlargement of the sealing segment, wherein the region of the cut-out enlargement is indicated by X in FIG. 1. One recognizes herein that the return structure is formed in a saw-threaded manner, wherein the triangular-like profile of the thread is formed such that the side of the triangle, which lies on the side of the free axial end of the sealing segment 22, is formed with a smaller inclination angle a relative to the shaft main axis than the other side. Said inclination angle α is thus, e.g., in the range of about 15°. Further, the radial thickness D of the annular-like region is about 0.6 mm. In other embodiments, said thickness can however be adapted in a diameter-dependent manner for adjustment of an intrinsic contact force. The width B of the thread is thus also about 0.6 mm outside of the transition region towards the free end. The depth T of the thread is thus about 0.15 mm. The ascending slope S of the gripping thread is about 0.75 mm. Further, the base of the thread is formed with a rounding having a radius R2 of less than 0.1 mm. Furthermore, at the transition of the thread to the annular-like region 26, a chamfer rounding having a radius R1 of about 0.1 mm is provided. The previously-mentioned dimensions thus concern a shaft diameter of about 50 mm. In particular due to the chosen ratio of the depth T to the width B, good return properties are thus achieved in connection with the triangular-like profile of the thread.

In an alternative embodiment, which is illustrated in FIG. 4 in a cut-out manner, the transition of the thread into an annular-like region 26′ can be formed such that the thread of the return structure transitions into the annular-like region with unchanged depth and decreasing width. This means that, in a triangular-like thread profile, the thread pitch is formed rectangular-like in the transition region, in particular corresponding to a trapezoid half and decreases with respect to its width. Relative to FIGS. 1 and 2, the annular-like region 26′ of FIG. 4 is designed more membrane-like in terms of a bending and/or opening towards the left side. Further, in this embodiment it is of particular advantage that clogging of the return structure in said transition region is counteracted due to the shape of the thread in the transition region.

Finally, FIG. 3 shows a longitudinal section through the sealing element of FIG. 1 at another circumferential position, wherein one recognizes that the elastomeric part 5 includes discrete interruptions on its left top side relative to the reinforcement part 2. Said discrete interruptions result from injection molding manufacturing of the elastomeric part 5, in which the elastomeric material is sprayed onto the reinforcement element 2, wherein the discrete interruptions are induced by a corresponding retaining device of the reinforcement part 2 during the injection molding.

FIG. 5 shows, as a further exemplary embodiment of the invention, a longitudinal section through an upper half of a sealing element in a second embodiment. The sealing element of

FIG. 5 differs from that of FIGS. 1 to 4 in that the elastomeric part is formed by a common elastomeric material, but in two-pieces, such that the first sealing region 10″ and the second sealing region 20″ are formed separated from each other from a material standpoint. Otherwise, the prior description for FIGS. 1 to 4 applies to the embodiment of FIG. 5 in a corresponding manner. Comparable structural elements are thus indicated with the same reference numerals, supplemented with two apostrophes.

Naturally, in other embodiments, combinations of the previously-described embodiments are possible.

In other embodiments, the return structure can naturally also be formed extending along the trumpet-like segment and/or can also be formed as a multi-step, screw-like groove, wherein in multi-step embodiments, in particular crescent-like grooves, as described in German patent application no. 10 2006 025 799.5, can also be utilized. In this case, the return structure can comprise at least three grooves disposed in a distributed manner in the circumferential direction, wherein one of the grooves can be formed in an extended manner in one segment of the sealing segment, which has a circumferential angle of smaller than or equal to 120°. Furthermore, at least one of the grooves can be formed in a curved manner, with at least one further, also curve-like formed groove in an intersecting manner and/or at least one of the grooves can be formed with a width enlarging towards the axial side, to which is to be returned. Further, at least one of the grooves can be formed transitioning in a ramp-like manner in the region having said line and/or the grooves can be formed with such a radial width so that only bridges remain in-between, whose abutment surfaces on the shaft extend on a circular cylinder in the region of the sealing segment.

In other embodiments, the thread can be, in the alternative or in addition to, interrupted by a bridge at at least one of the points spaced from the free axial end, so that the thread peaks form, in a 360° region about the bridge points together with the bridge, a closed line in the circumferential direction extending on a circular cylinder surface; the line abuts on the shaft at least when the shaft is not rotating.

In one embodiment, the housing part can be formed, e.g., as a covering element, in which the sealing element is disposed in a corresponding manner, wherein the covering element is screwed onto the rest of the housing of the internal combustion engine and/or is adhered using a sealing material, for which purpose the sealing element can be designed with at least one correspondingly-formed grove for the sealing material.

In another embodiment, a sealing element can naturally also be formed so that the elastomeric part does not completely encompass the outer surface of the reinforcement part, so that parts of the reinforcement part as well as also parts of the elastomeric part come into abutment on the housing part for rotating in accordance with its design for a correspondingly-formed reinforcement part.

In another embodiment, the secondary sealing lip can also be formed from a fibrous web material, with which a certain breathing activity and/or a filter effect can then also be achieved when the secondary sealing lip abuts on the shaft.

1. A sealing element for sealing a though-opening between a rotatable shaft and a housing for the shaft, the sealing element comprising:
a reinforcement part; and
an elastomeric part connected with the reinforcement part, the elastomeric part including a first sealing region for a static-sealing abutment on the housing and
a second sealing region having a sealing segment configured for sealing abutment on the shaft, the sealing segment including a thread-like return structure configured to direct leaked fluid back into a space sealed by the sealing element during rotation of the shaft and a generally closed inner circumferential sealing surface at a free axial end of the sealing segment, the sealing surface being configured for sealing abutment on the shaft at least when the shaft is non-rotational.

2. The sealing element according to claim 1, wherein the free axial end of the second sealing region is generally annular.

3. The sealing element according to claim 1, wherein the thread-like return structure is configured to grip the shaft.

4. The sealing element according to claim 1, wherein the return structure is formed in a saw-thread-like manner.

5. The sealing element according to claim 1, wherein the profile of the thread pitch of the return structure is formed having a generally triangular shape.

6. The sealing element according to claim 5, wherein a side of the triangular thread facing generally toward the free axial end of the sealing segment is formed with a smaller inclination relative to the shaft main axis than side an opposing side of the triangular thread.

7. The sealing element according to claim 6, wherein the inclination in one region is between 10° and 30°.

8. (canceled)

9. The sealing element according to claim 1, wherein the thread of the return structure is designed to transition with a narrowing depth, but with a profile that remains proportioned the same, into the region of the closed line.

10. The sealing element according to claim 1, wherein the thread of the return structure is designed to transition with an unchanging depth and decreasing width into the region of the closed line.

11. The sealing element according to claim 10, wherein, in a triangular thread profile in the transition portion, the thread is formed in a rectangular manner, in particular corresponding to a trapezoid half having decreasing width.

12. The sealing element according to claim 1, wherein the thread is formed with a ratio of a depth of the thread to a width of the thread between 0.1 and 0.3.

13. (canceled)

14. The sealing element according to claim 1, wherein the inner circumferential sealing surface has a radial thickness of between 0.3 and 1.0 mm.

15. (canceled)

16. The sealing element according to claim 1, wherein the thread of the return structure is formed with a depth between 0.05 and 0.3 mm.

17. (canceled)

18. The sealing element according to claim 1, wherein the thread of the return structure is formed with a width between 0.4 and 0.9 mm.

19. (canceled)

20. The sealing element according to claim 1, wherein the elastomeric part further includes a secondary sealing lip.

21. The sealing element according to claim 1, wherein the elastomeric part is formed from an elastomeric material including at least one of a fluoroelastomer, AEM and ACM.

22. The sealing element according to claim 21, wherein the elastomeric material includes PTFE-nanoparticles.

23. The sealing element according to claim 1, wherein the first and second sealing regions are formed of a same elastomeric material.

24. The sealing element according to claim 1, wherein the elastomeric part is formed in one-piece.

25. The sealing element according to claim 1, wherein the elastomeric part is formed from at least two spaced-apart pieces, one of the pieces including the first sealing region and another piece including the second sealing region.

26. The sealing element according to claim 1, wherein the elastomeric part is vulcanized onto the reinforcement part.

27. The sealing element according to claim 1, wherein the reinforcement element is configured for abutment on the housing.

28. The sealing element according to claim 1, wherein the sealing segment is generally formed as a hollow cylinder.

29. The sealing element according to claim 1, wherein the sealing segment includes a generally trumpet-like section.

30. The sealing element according to claim 29, wherein the trumpet-like segment includes a part of the return structure.

31. (canceled)

32. The sealing element according to claim 1, wherein the sealing element is formed as a radial shaft sealing ring.
